(19) United States
(12) Patent Application Publication
(10) Pub. No.: US 2004/0000345 A1
(43) Pub. Date: Jan. 1, 2004

(54) Reservoir unit

(76) Inventors: Yoichi Nakao, Ohbu (JP); Nobuo Suzuki, Ohbu (JP)

Correspondence Address: STEVENS, DAVIS, MILLER & MOSHER, L.L.P., Suite 850, 1615 L Street, N.W., Washington, DC, 20036, US

(21) Appl. No.: 10/465,892

(22) Filed: Jun. 20, 2003

(30) Foreign Application Priority Data
Jun. 28, 2002 (JP) 2002-190044

(51) Int. Cl. F02M 37/04

(52) U.S. Cl. 137/565.34

(57) ABSTRACT

In a reservoir unit for use in a marine vessel, in order to prevent in a simple structure water having accumulated on the bottom of the fuel tank from entering the reservoir or, even if the water enters the reservoir, to make possible its draining, an opening is bored in the bottom plate of the reservoir to be installed in the fuel tank for the marine vessel, and elevating legs are provided on the outer face of the bottom plate. Further an extension cylinder extending upwards from the reservoir is fixed to the reservoir, a cylindrical portion extending downwards is formed on the upper subunit, and the cylindrical portion and the extension cylinder are fitted one inside the other to make the distance between the reservoir and the upper subunit variable. In addition, the reservoir is so structured as to have on the inner face of its bottom plate a slope inclined downwards towards the opening.

### BACKGROUND OF THE INVENTION

1. Field of the Invention

The present invention relates to a reservoir unit to be installed in a fuel tank of a marine vessel.

2. Description of the Related Art

According to an existing technique, a cylindrical reservoir having a bottom is installed in a fuel tank and a jet pump is provided in that reservoir to enable the fuel in the fuel tank to be let into the reservoir. This technique makes it possible, even if the fuel remaining in the fuel tank has much decreased and the oil level in the fuel tank has dropped, to keep the oil level in the reservoir sufficiently high. When a fuel pump is provided in this reservoir, even if the quantity of fuel remaining in the fuel tank is very small and the oil level is very low, it can prevent the fuel pump from sucking the air in the tank. The technique, as the fuel pump sucks the air, can serve to keep small the volume of fuel that cannot be fed out of the fuel tank. In other words, the capacity of the fuel tank can be utilized more effectively.

In a marine vessel, on account of the environment of its use, water may enter the fuel tank. As the specific gravity of water is greater than that of the fuel, the water entering the fuel tank gathers in the bottom part of the fuel tank. As the fuel intake port of the jet pump is positioned near the bottom of the fuel tank, the water gathering in the bottom part of the fuel tank is apt to be let into the reservoir by the jet pump. If that water is supplied by the fuel pump to an injector, the engine may stop running.

In view of this problem, the present invention proposes a structure, though a simple one, that can reduce the possibility of allowing the water gathering in the bottom part of a fuel tank to enter a reservoir. It also proposes a structure that enables, even if water enters the reservoir, the water to be drained without delay.

### SUMMARY OF THE INVENTION

The present invention makes use of a finding that water gathering in the bottom part of a fuel tank is made more difficult to enter the reservoir by providing elevating legs on the outer face of the bottom plate of the reservoir and thereby segregating the bottom face of the fuel tank and the bottom plate of the reservoir from each other. It also makes use of a finding that water entering the reservoir can be drained without delay by boring an opening in 'the bottom plate of the reservoir segregated from the bottom face of the fuel tank.

A reservoir unit according to the invention is intended solely for installation and use in a fuel tank of a marine vessel. This unit has an upper subunit fixed to the upper face of a fuel tank and a lower subunit. The lower subunit has a reservoir pressed against the bottom face of the fuel tank, a fuel filter accommodated in the reservoir, and a fuel pump accommodated in the reservoir. On the upper subunit is formed a cylindrical portion extending downwards. To the reservoir is fixed an extension cylinder extending upwards, and an opening is bored in the bottom plate of the reservoir, with elevating legs being formed on the outer face of the bottom plate. The cylindrical portion formed on the upper subunit and the extension cylinder fixed to the reservoir are slidably fitted one inside the other. Because of this arrangement, the distance between the reservoir and the upper subunit is variable.

In the configuration described above, the elevating legs formed on the outer face of the bottom plate of the reservoir segregate the bottom face of the fuel tank and the bottom plate of the reservoir from each other. As a result, the fuel intake port of the jet pump are separated from the bottom face of the fuel tank, making it possible to restrain the jet pump from letting water gathering in the bottom part of the fuel tank enter the reservoir. Even if water has been let into the reservoir, the water drain hole bored in the bottom plate of the reservoir causes the water, which has a greater specific gravity than fuel, to be quickly discharged from the reservoir by gravity.

A marine vessel, which may navigate rough seas in a stormy weather, is subject to a severe acceleration, and its fuel tanks might suffer an impactive acceleration. The reservoir unit according to the invention can endure even such impactive accelerations because it has a double-cylinder structure in which the extension cylinder extending upwards from the reservoir is fixed to the reservoir and the cylindrical portion extending downwards is formed on the upper subunit and those cylindrical portion and extension cylinder are fitted one inside the other.

The downward inclination of the inner face of the bottom plate of the reservoir toward its opening is another advantage. In this arrangement, even if water has been let into the reservoir, the water, which has a greater specific gravity than fuel, is quickly discharged from the reservoir by gravity through the hole bored in the bottom of the reservoir.

### BRIEF DESCRIPTION OF THE DRAWINGS

FIG. 1 shows a schematic front sectional view of a whole reservoir unit, which is a first preferred embodiment according to the present invention, and represents a section along line I-I in FIG. 5A.

FIG. 2 shows a schematic side view of the whole reservoir unit, which is the first preferred embodiment.

FIG. 3 shows a section of the reservoir unit, which is the first embodiment, and represents a section along line III-III in FIG. 5A.

FIG. 4 shows a front view of the reservoir unit, which is the first embodiment.

FIG. 5A shows a plan view of the reservoir unit, which is the first embodiment, and FIG. 5B, a section of a jet pump in FIG. 5A along the center line (VB-VB line).

FIG. 6A shows a front view of the partition shown in FIG. SA, and FIGS. 6B and 6C, modifications of the partition.

FIG. 7 is a partial enlargement of FIG. 1, showing a section of the primary filter.

### DESCRIPTION OF THE PREFERRED EMBODIMENTS

The following paragraphs enumerate principal features of the preferred embodiment according to the present invention to be described below.

(Mode 1) An upper subunit and a reservoir in a lower subunit are slidable connected by an extension cylinder, and their positional relationship in the horizontal direction is firmly maintained by a rod penetrating them.

(Mode 2) Between the upper subunit and the reservoir is set a compression spring, whose elastic force presses the reservoir against the bottom face of the fuel tank.

(Mode 3) A primary filter is composed of a bag filter of fine nylon texture and a resin-made frame inserted in the filter and securing a certain volume within the bag.

(Mode 4) The bag is configured of an expansive portion which presses a few parts of the bottom face of the bag filter against the bottom face of the reservoir and a frame body which maintains the remaining portion of the bag filter in a position slightly away from the bottom face of the reservoir.

(Mode 5) The reservoir is molded of resin, and with this molded body are integrally molded a fitting portion for a jet pump body and a wall against which a jet stream from the jet pump hits.

(Mode 6) The reservoir is substantially cylindrically shaped, and the space inside the reservoir accommodates a fuel pump and a pressure regulator.

(Mode 7) The jet pump, fuel filter, fuel pump and pressure regulator are assembled with the reservoir. In other words, all of the jet pump, fuel filter, fuel pump and pressure regulator are fabricated in advance as an assembly with the reservoir.

[Embodiment]

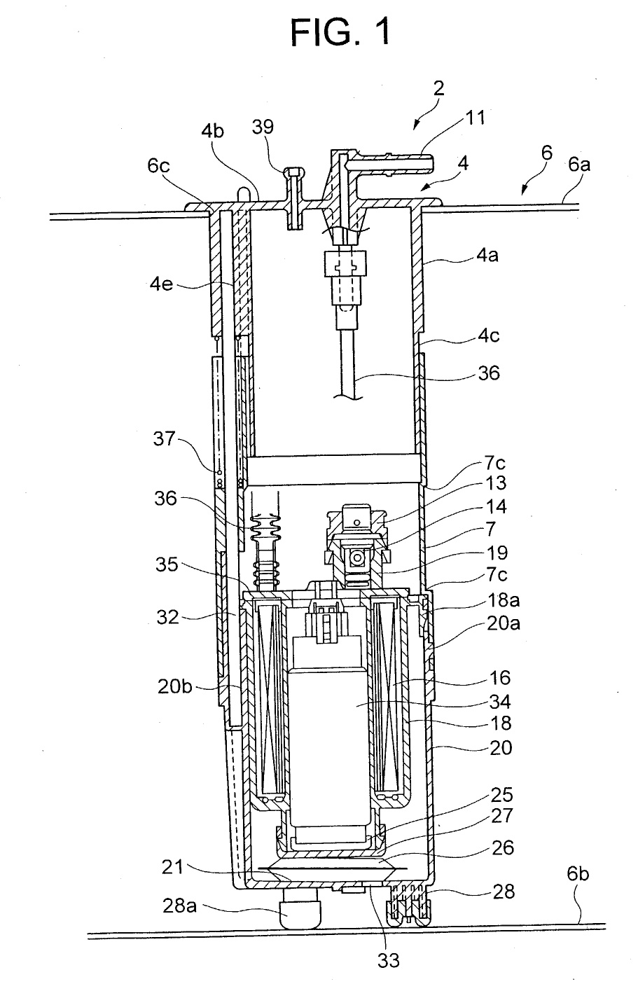

The reservoir unit, which is the first preferred embodiment according to the invention will be described in detail with reference to FIG. 1.

As shown in FIG. 1, a reservoir unit 2 embodying the invention comprises an upper subunit 4, a lower subunit 8 and an extension cylinder 7, and is installed in a marine vessel fuel tank 6 when it is used. The lower subunit 8 is provided with a cylindrical reservoir 20 having a bottom (i.e. substantial in a drinking glass shape), on an outer face of which elevating legs 28 are provided, a primary filter 26, a fuel pump 34, a pressure regulator 14 and a secondary filter 16. The primary filter 26, fuel pump 34, pressure regulator 14 and secondary filter 16 are accommodated and positioned in the reservoir 20, and integrated into an assembly.

In the following paragraphs, the primary filter 26, fuel pump 34, pressure regulator 14, secondary filter 16, reservoir 20 and upper subunit 4 will be described in detail in this order.

The primary filter 26 is configured of a bag filter of fine nylon texture and a resin-made frame inserted in the filter and securing a certain volume within the bag. The internal space of the bag filter communicates with the intake port of the fuel pump 34.

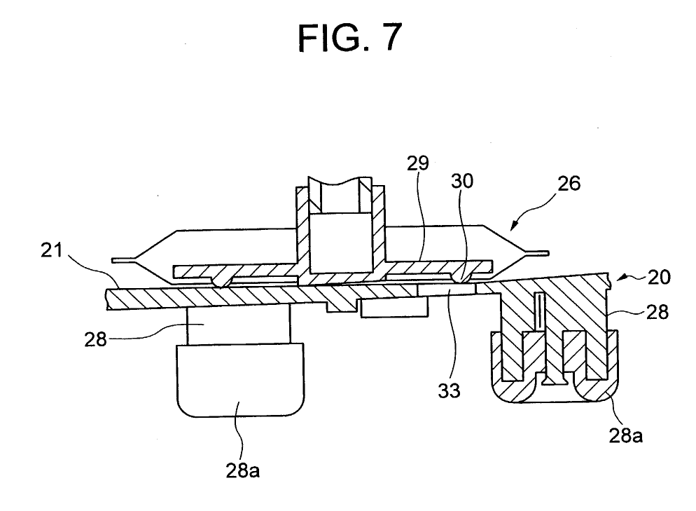

The primary filter 26 is accommodated in the reservoir 20, and arranged along the bottom face of the reservoir 20. As shown in FIG. 7, the frame is configured of an expansive portion 30 which presses a few parts of the bottom face of the bag filter against the bottom face of the reservoir 20 and a frame body 29 which maintains the remaining portion of the bag filter in a position slightly away from the bottom face of the reservoir 20. This arrangement ensures a gap between the bottom face of the primary filter 26 and the bottom face of the reservoir 20 to enable the whole face of the filter to accomplish filtration.

In the bag filter of fine nylon texture, when exposed from fuel, the fuel fills up the texture by its surface tension. As long as the bag filter, even only a small portion of it, is soaked in the fuel, the fuel finds its way into the filter, and therefore the fuel, even if its remaining volume is so small that the top of the bag filter is exposed, can still be pumped up. Any foreign matter in the fuel is mostly removed by the primary filter 26, and the remaining foreign matter is removed by the secondary filter 16 to be described below. The fuel cleared of foreign matter by the primary filter 26 is sucked up by the fuel pump.

As shown in FIG. 1, the fuel pump 34 has a vertical substantially columnar shape, and has a fuel intake pipe (not shown) at its bottom. To the fuel intake pipe (not shown) is connected the primary filter 26. At the upper end of the fuel pump 34 is provided a fuel discharge port, which is inserted into and set in the fuel discharge port receptacle of a filter cover 35. In the filter cover 35 are formed, in addition to the fuel discharge port receptacle, a fuel passage, a pressure regulator fitting portion 19 and a fuel outlet. The fuel passage extends from the fuel discharge port receptacle to the fuel outlet by way of the pressure regulator fitting portion 19. The fuel outlet opens into the inner chamber of the secondary filter to be described below. The fuel pump 34 is driven by being fed with electricity via an electrical connector (not shown), sucks fuel in the reservoir 20, to be described below, through the primary filter 26, raises its pressure and discharges it through the fuel discharge port.

To the fuel discharge port is connected the pressure regulator 14. The pressure regulator 14 is a relief valve for keeping the pressure in the fuel passage at a prescribed level by letting some of the fuel escape through the fuel passage when the pressure in the fuel passage has surpassed the prescribed level, and controls the pressure of the fuel to be supplied to the secondary filter 16 and accordingly the pressure of the fuel to be supplied to the internal combustion engine at a prescribed level. The fuel having escaped from the pressure regulator 14 is guided by piping (not shown in FIG. 1) to a jet pump 40 to be described below. The pressure regulator 14 is accommodated in the pressure regulator fitting portion 19 of the filter cover 35 to be described below, and is supported in a state of being prevented from coming off by the incorporation of a cap 13 into the pressure regulator fitting portion 19 of the filter cover 35.

Around the fuel pump 34 is formed a doughnut-shaped vessel 18, and in that doughnut-shaped vessel 18 is accommodated the doughnut-shaped secondary filter 16, which is covered by the filter cover 35 blocking an opening in the upper face of the doughnut-shaped vessel 18. The doughnut-shaped vessel 18 and the filter cover 35 are molded resin items. The doughnut-shaped vessel 18 is bisected into an inner chamber and an outer chamber by the doughnut-shaped secondary filter 16, and the fuel discharge port and the pressure regulator 14 communicate with the inner chamber of the doughnut-shaped vessel 18. A fuel feed pipe 36 communicates with the outer chamber of the doughnut-shaped vessel 18. Fuel delivered from the fuel pump 34 passes the secondary filter 16 from the inner chamber of the doughnut-shaped vessel 18, reaches the outer chamber of the doughnut-shaped vessel 18, and enters the fuel feed pipe 36. The fuel feed pipe 36 penetrates the upper subunit 4 and communicates with a nozzle 11, which extends out of the fuel tank 6. In this embodiment of the invention, the nozzle 11 is connected to an injector via a delivery pipe (neither shown), and supplies the injector with fuel pressurized by the fuel pump 34, adjusted by the pressure regulator 14 to a constant pressure and cleared of foreign matter by the primary filter 26 and the secondary filter 16.

The fuel pump 34 is inserted into the hollow portion of the doughnut-shaped vessel 18 through the opening in its bottom face. Installation of a fitting stay 27 on the bottom of the doughnut-shaped vessel 18 serves to support the fuel pump 34 in a state of freedom from coming off. Between the fuel pump 34 and the fitting stay 27 intervenes a rubber cushion 25, and the fuel pump 34 is elastically supported.

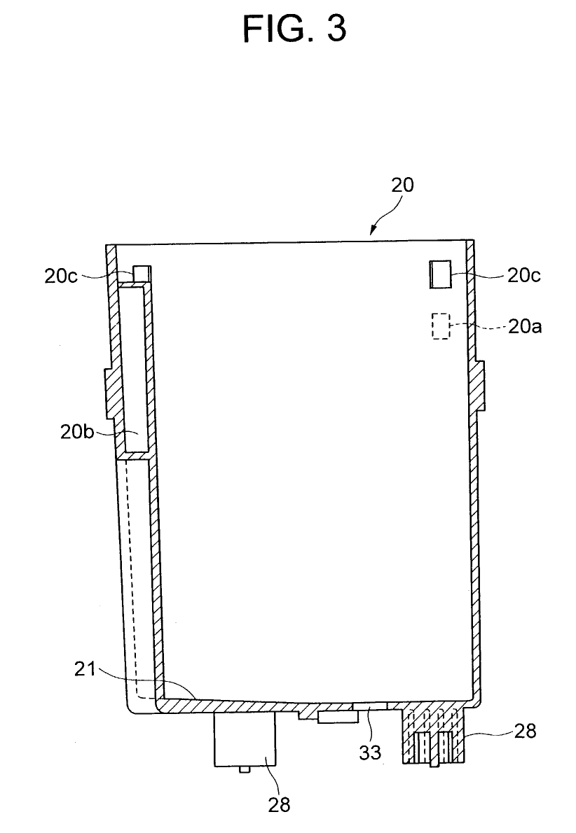

Next will be described, the reservoir 20. As is well shown in FIG. 3, elevating legs 28 are provided in a few positions on the outer face of the bottom plate of the reservoir 20. The bottom plate of the reservoir 20 also has a water drain hole 33 bored in it. The inner face of the bottom plate is provided with a slope 21 inclined downwards to the hole 33. The elevating legs 28 are fitted, by pressure fitting or otherwise, with elastic caps 28a of rubber or the like for damping impacts as shown in FIG. 7.

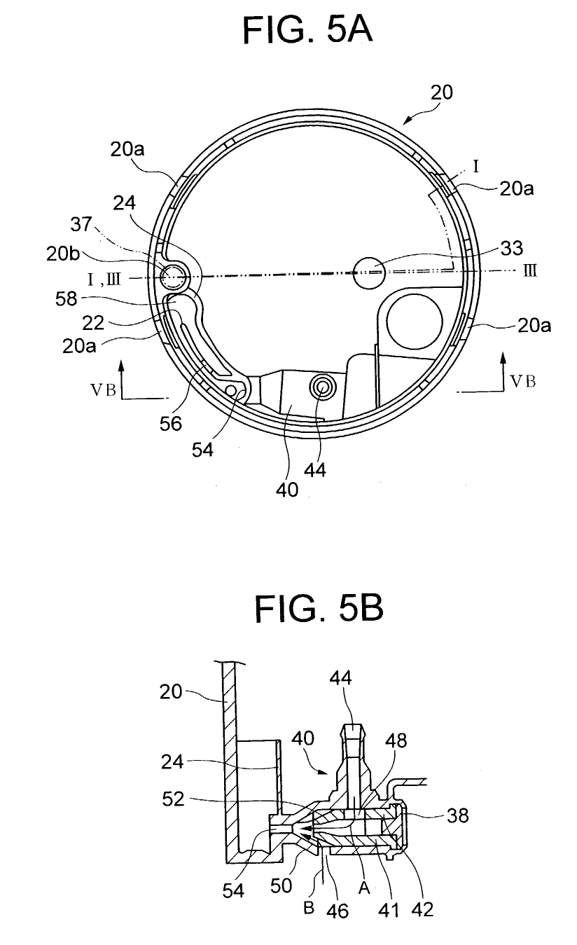

FIG. 5A is a plan view of the reservoir 20, and FIG. 5B, a section of the jet pump 40 taken along the center line (VB-VB line). In the bottom face of the reservoir unit 20 molded of resin item is formed a concave 42 to accept the body 41 of the jet pump 40, and openings 44 and 46 communicating with the concave are formed penetrating the wall of the reservoir 20. To the opening 44 is fitted a hose for connecting the pressure regulator 14 and the opening 44, and return fuel from the pressure regulator 14 is thereby guided to the opening 44. The opening 46 opens into the space between the bottom face of the reservoir 20 and the bottom face 6b of the fuel tank 6 in FIG. 1. The opening 46 is distant upwards from the bottom face 6b of the fuel tank 6 by the elevating legs 28.

As shown in FIG. 5B, the jet pump body 41 is accommodated in the concave 42, and the subsequent fixation of a plug 38 to the reservoir 20 fixes it to the reservoir 20. The jet pump body 41 is provided with an opening 48 for receiving return fuel from the pressure regulator 14 and a venturi tube 52, and the jet pump 40 is provided with a passage 50 for accepting fuel outside the reservoir 20. When the jet pump body 41 is fixed to the reservoir 20, the opening 44 communicates with the opening 48, and the opening 46, with the passage 50.

When the return fuel from the pressure regulator 14 is guided to the opening 44, that fuel passes the venturi tube 52 of the jet pump body 41 as indicated by arrow A in FIG. 5B. As the flow rate of the return fuel ejected from the venturi tube 52 is fast, a negative pressure generates downstream from the venturi tube 52. This negative pressure causes fuel outside the reservoir 20 to pass the opening 46 and the passage 50, to be sucked into the jet pump 40, and to be discharged from the discharge port 54 of the jet pump 40. As the opening 46 is distant upwards from the bottom face 6b of the fuel tank 6 by the elevating legs 28, even if water enters the fuel tank 6 and has accumulated in the bottom part of the fuel tank 6, not water but fuel is sucked through the opening 46. Even if water has accumulated on the bottom of the fuel tank 6, the water can hardly become mixed with the fuel in the reservoir 20.

From the discharge port 54 of the jet pump 40 are discharged return fuel from the pressure regulator 14 and fuel sucked from outside of the reservoir 20. The jet pump 40, utilizing the velocity of the return fuel from the pressure regulator 14, guides fuel outside the reservoir 20 into the reservoir 20.

Fuel discharged from the discharge port 54 of the jet pump 40 contains many bubbles. If this fuel is vigorously discharged into the reservoir 20, the reservoir may be filled with fuel containing bubbles. If the reservoir 20 is filled with bubbly fuel, the fuel pump 34 may suck many bubbles and become vapor-locked or the bubbly fuel may be supplied to the injector and make it impossible for the injector to inject the intended quantity of fuel.

In order to prevent the reservoir 20 from being filled with bubbly fuel, in this embodiment, a wall 24 fully surrounding the discharge port 54 of the jet pump 40 is molded integrally with the resin-made reservoir 20 as shown in FIGS. 5A and 5B. Thus, the discharge flow from the jet pump 40 is sent into a closed space fully surrounded by the wall 24, and the fuel, as long as it is in the closed space, is cleared of the bubbles, and is shifted outside the wall 24 after it is cleared of bubbles. It is thereby prevented to let fuel present within the reservoir 20 outside the wall 24 contain many bubbles.

As shown in FIG. 5A, the wall 24 fully surrounds the discharge port 54 of the jet pump 40. Its height is lower than the side walls of the reservoir 20. The wall 24 should preferably have, though not particularly limited to, a shape having no corners in a planar view, such as a bean shape, a substantial oval or a substantial circle, because corners might invite concentration of bubbles in the fuel therein.

The configuration is such that a partition 22 is formed in the central part of the fully surrounding wall 24, and the discharge flow from the jet pump 40 goes round the partition 22. The discharge flow from the jet pump 40 is let out along the partition 22.

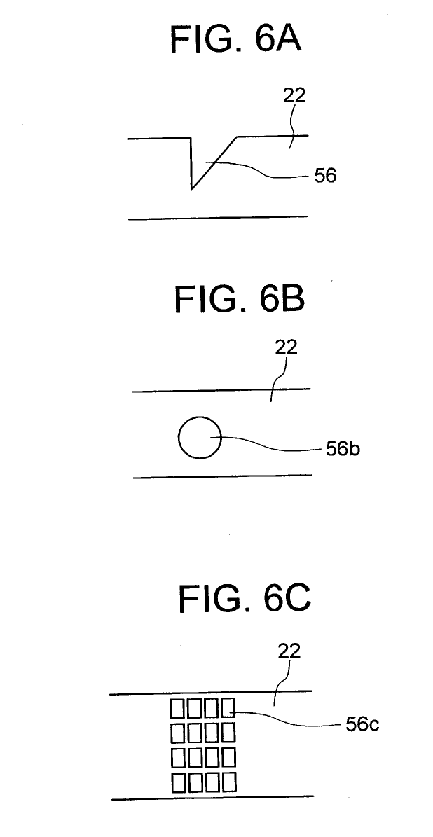

Between the two sides of the partition 22 and the fully-surrounding wall 24 are secured clearances 56 and 58. The clearance 56 can be formed by notching part of the partition 22 as shown in FIG. 6A. It is adequate for the clearance 56 to allow the discharge flow to turn round the partition 22 a plurality of times, and a hole-shaped clearance 56b as shown in FIG. 6B, a mesh-shaped clearance 56c shown in FIG. 6C or the like may be applied as appropriate.

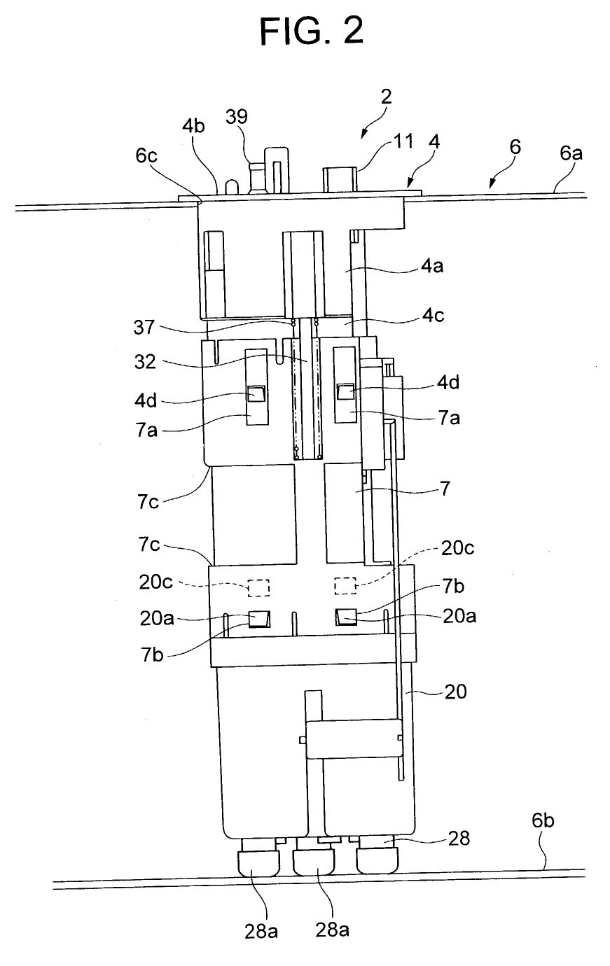

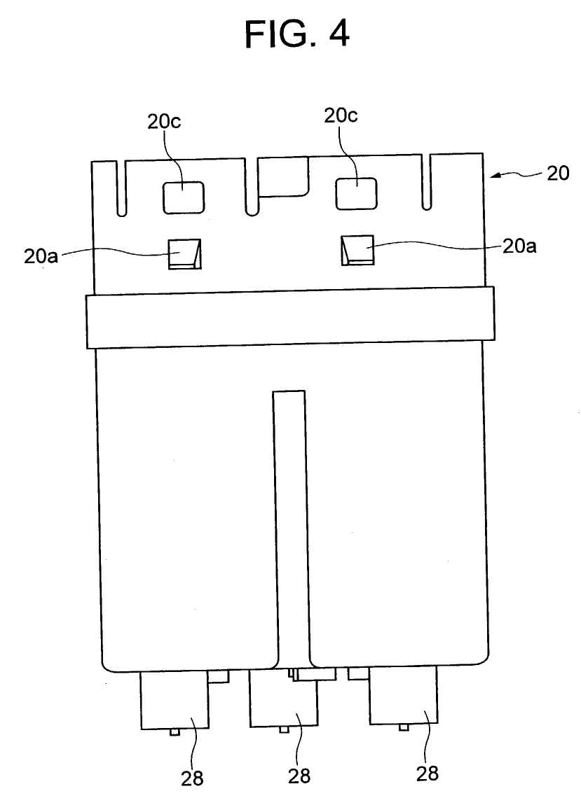

Next will be described engagement between the reservoir 20 and an extension cylinder 7. As is well shown in FIG. 4, on the outer circumferential face of the upper part of the reservoir 20 are formed a plurality of tapered projections 20a. As is well depicted in FIG. 2, the outer circumferential face of the upper part of the reservoir 20 is capped with the extension cylinder 7. In the circumferential face of the lower part of the extension cylinder 7 are bored engaging holes 7b. When the outer circumferential face of the upper part of the reservoir 20 is capped with the extension cylinder 7, the tapered projections 20a provided on the reservoir 20 and the engaging holes 7b bored in the extension cylinder 7 engage with each other, and the extension cylinder 7 is fixed to the reservoir 20. The extension cylinder 7 extends upwards from the reservoir 20.

Further, the engaging holes 20c bored in the circumferential face of the upper part of the reservior 20 engage with a plurality of projections 18a (see FIG. 1) protruding from the doughnut-shaped vessel 18 for the secondary filter 16 mentioned above as shown in FIG. 1 through FIG. 4, and thereby serve to fix the doughnut-shaped vessel 18 to the reservoir 20.

Next, the upper subunit 4 will be described. The upper subunit 4, which is a molded resin item, is provided with a substantially circular disk section 4b fixed to the upper face 6a of the fuel tank 6 to block an opening 6c in the fuel tank 6, a cylindrical wall 4a protruding from the under face of this disk section 4b, and an inner fitted cylindrical portion 4c extending farther downwards from the cylindrical wall 4a. The cylindrical wall 4a can be fitted into the fitting hole 6c of the fuel tank 6. As shown in FIG. 1, the fitting of the upper subunit 4 to block the fitting hole 6c of the fuel tank 6 serves to arrange and position the reservoir unit 2 in the fuel tank 6. The outer periphery of the upper subunit 4 is mounted onto the edge of the fitting hole 6c of the fuel tank 6 via a seal gasket (not shown) and fastened to the edge of the fitting hole 6c with bolts (not shown). This results in fixation of the upper subunit 4 to the fuel tank 6.

The upper subunit 4 has an electrical connector (not shown), and is electrically connected to the electrical connector of the fuel pump 34 on the under face side of the upper subunit 4. The electrical connector is electrically connected to an electricity feed connector (not shown) on the upper face side of the upper subunit 4. Further an atmosphere port 39 is provided vertically penetrating the disk section 4b to be used for controlling the pressure within the fuel tank 6.

As shown in FIG. 2, the cylindrical portion 4c extends farther down from a wall 4a of the upper subunit 4. Tapered projections 4d are provided on the outer circumferential face of the cylindrical portion 4c. The cylindrical portion 4c is fitted on the extension cylinder 7 one inside the other. In the fitting process, the outer circumferential face of the extension cylinder 7 is elastically deformed and rides over the tapered projections 4d provided on the cylindrical portion 4c, so that the projections 4d fit into slotted holes 7a. During normal use, the tapered projections 4d are engaged with end parts of the slotted holes 7a so that the upper subunit 4 and the extension cylinder 7 may not separate from each other. The slotted holes 7a bored in the extension cylinder 7 are given a sufficient length in the vertical direction to be able to comply with dimensional variations due to changes in the internal pressure of the fuel tank 6, the upper subunit 4 and the extension cylinder 7 are slidable relative to each other in a state in which the slotted holes 7a and the tapered projections 4d are engaged with each other.

To add, the extension cylinder 7 is provided with a diameter-contracted portion 7c to prevent the upper subunit 4 and the reservoir 20 from being fitted to each other beyond a certain depth.

As shown in FIG. 1, a metallic rod 32 penetrates the upper subunit 4, the extension cylinder 7 and the reservoir 20 to firmly maintain the positional relationship among the upper subunit 4, the extension cylinder 7 and the reservoir 20 in the horizontal direction so that the relationship may not be disturbed by a severe acceleration or the like. The metallic rod 32 is inserted into and fixed in a hole 20b in the reservoir 20, and can be slid within a hole 4e in the upper subunit 4. A coil-shaped compression spring 37 is set around the rod 32 between the upper subunit 4 and the reservoir 20, and its elastic force presses the reservoir 20 toward the bottom face 6b of the fuel tank 6. The fuel tank 6 is blow-molded of resin, and is deformed by variations in the remaining fuel quantity and atmospheric temperature. The lower subunit 8 is pressed all the time towards the bottom face 6b of the fuel tank 6 by the elastic force of this compression spring 37 to comply with the deformation of the fuel tank 6.

Although a specific example of the present invention has been described in detail, this is nothing more than an example but does not limit the scope of claims thereon. The aspects of the technique described in the claims include various modifications and variations of the specific example described so far.

The technical elements taken up in this specification or the drawings accompanying it can exert technical utility either individually or in various combinations, but not limited to the combinations described in the claims in the application at the time of its filing. The techniques taken up in this specification or the drawings accompanying it can achieve a plurality of objects at the same time, and achievement of any one of those objects in itself can be technically useful.

According to the present invention, it is possible to restrain the possibility for water having accumulated in the fuel tank to find its way into the reservoir by providing elevating legs on the outer face of the bottom of the reservoir and thereby segregating the bottom of the fuel tank and the bottom of the reservoir from each other. Even if water enters the reservoir, as a water drain hole is bored in the bottom of the reservoir, water which is greater in specific gravity than fuel is quickly discharged through the hole bored in the bottom by gravity. As the bottom plate of the reservoir is segregated upwards from the bottom of the fuel tank, even if water gathers in the fuel tank, any water entering the reservoir flows out of the reservoir quickly and without fail, because the bottom plate of the reservoir is positioned higher than the water level.

According to the invention, if the inner face of the bottom plate of the reservoir is inclined downwards towards the opening in the bottom, even if water enters the reservoir, the water can quickly flow out through the water drain hole in the bottom of the reservoir because of its greater specific gravity than that of fuel.

What is claimed is:

1. A reservoir unit for installation in a fuel tank of a marine vessel, comprising:
an upper subunit to be fixed to the upper face of the fuel tank, and
a lower subunit having a reservoir to be pressed against the bottom face of the fuel tank, a fuel filter accommodated in the reservoir and a fuel pump accommodated in the reservoir, wherein:
a cylindrical portion extending downwards is formed in the upper subunit,
an extension cylinder extending upwards is fixed to the reservoir, an opening being bored in the bottom plate of the reservoir and elevating legs being formed on an outer face of the bottom plate, and
the cylindrical portion and the extension cylinder are fitted one inside the other slidably in the vertical direction to make the distance between the reservoir and the upper subunit variable.

2. A reservoir unit as claimed in claim 1, wherein an inner face of the bottom plate of the reservoir is inclined downwards towards said opening.

3. A reservoir unit as claimed in claim 1, wherein a cap consisting of an elastic material is provided on each of said elevating legs.

4. A reservoir unit as claimed in claim 2, wherein a cap consisting of an elastic material is provided on each of said elevating legs.
